(19) United States
(12) Patent Application Publication
(10) Pub. No.: US 2017/0019647 A1
(43) Pub. Date: Jan. 19, 2017

(54) IMAGE PROJECTION APPARATUS AND IMAGE PROJECTION METHOD

(71) Applicant: Takahiro KADO, Kanagawa (JP)

(72) Inventor: Takahiro KADO, Kanagawa (JP)

(73) Assignee: Ricoh Company, Ltd., Tokyo (JP)

(21) Appl. No.: 15/203,916

(22) Filed: Jul. 7, 2016

(30) Foreign Application Priority Data
Jul. 17, 2015 (JP) 2015-142604

(51) Int. Cl. H04N 9/31; G02B 26/08; G03B 21/20

(52) U.S. Cl. CPC H04N 9/3155; H04N 9/3102; H04N 9/3144; G03B 21/2053; H04N 9/3194; G02B 26/0833

(57) ABSTRACT

An image projection apparatus includes a projector including a light source and an image generator configured to use light emitted from the light source to generate a projection image while moving between a plurality of image generation positions; an illuminance detector configured to detect illuminance in an environment in which the image projection apparatus is disposed; a control amount setter configured to set a non-projection time based on the illuminance detected by the illuminance detector; and a projection controller configured to control the projector so as not to generate the projection image during the non-projection time, while the image generator is moving between the plurality of image generation positions.

### CROSS-REFERENCE TO RELATED APPLICATION

The present application claims priority under 35 U.S.C. §119 to Japanese Patent Application No. 2015-142604, filed on Jul. 17, 2015. The contents of which are incorporated herein by reference in their entirety.

### BACKGROUND OF THE INVENTION

1. Field of the Invention

The present invention relates to an image projection apparatus and an image projection method.

2. Description of the Related Art

In an image projection apparatus for projecting images onto a screen, etc., based on input image data, there is known a method of slightly shifting the projection image at high speed to increase the resolution of the projection image in a pseudo manner and improve the image quality.

For example, when the projection image is shifted between a plurality of projection positions, when an image is projected at a middle position between the projection positions, the effect of increasing the resolution of the projection image may be decreased. Thus, there is proposed an image display apparatus that implements control of not displaying projection images while the centroid of the pixels is moving and during a stable period until a predetermined pixel is displayed (see, for example, Patent Document 1).

Patent Document 1: Japanese Unexamined Patent Application Publication No. 2004-180011

### SUMMARY OF THE INVENTION

An aspect of the present invention provides an image projection apparatus and an image projection method in which one or more of the above-described disadvantages are eliminated.

According to one aspect of the present invention, there is provided an image projection apparatus including a projector including a light source and an image generator configured to use light emitted from the light source to generate a projection image while moving between a plurality of image generation positions; an illuminance detector configured to detect illuminance in an environment in which the image projection apparatus is disposed; a control amount setter configured to set a non-projection time based on the illuminance detected by the illuminance detector; and a projection controller configured to control the projector so as not to generate the projection image during the non-projection time, while the image generator is moving between the plurality of image generation positions.

### BRIEF DESCRIPTION OF THE DRAWINGS

Other objects, features and advantages of the present invention will become more apparent from the following detailed description when read in conjunction with the accompanying drawings, in which:

FIG. 1 is a diagram showing a projector which is an image projection apparatus according to an embodiment of the present invention;

FIG. 2 is a block diagram showing a functional configuration of the projector according to an embodiment of the present invention;

FIG. 3 is a perspective view of an optical engine of the projector according to an embodiment of the present invention;

FIG. 4 is a diagram showing a lighting optical system unit according to an embodiment of the present invention;

FIG. 5 is a diagram showing an internal configuration of a projection optical system unit;

FIG. 6 is a perspective view of an image displaying unit according to an embodiment of the present invention;

FIG. 7 is a side view of the image displaying unit according to an embodiment of the present invention;

FIG. 8 is a perspective view of a fixed unit according to an embodiment of the present invention;

FIG. 9 is an exploded perspective view of the fixed unit according to an embodiment of the present invention;

FIG. 10 is a diagram showing a support structure of a movable plate held by the fixed unit according to an embodiment of the present invention;

FIG. 11 is an enlarged diagram showing a portion of the support structure of the movable plate held by the fixed unit according to an embodiment of the present invention;

FIG. 12 is a bottom view of a top cover according to an embodiment of the present invention;

FIG. 13 is a perspective view of a movable unit according to an embodiment of the present invention;

FIG. 14 is an exploded perspective view of the movable unit according to an embodiment of the present invention;

FIG. 15 is a perspective view of a movable plate according to an embodiment of the present invention;

FIG. 16 is a perspective view of the movable unit from which the movable plate is removed according to an embodiment of the present invention;

FIG. 17 is a diagram showing a DMD holding structure of the movable unit according to an embodiment of the present invention;

FIG. 18 is a block diagram illustrating a functional configuration of a projector according to an embodiment of the present invention;

FIG. 19 is a diagram illustrating an example of a projection image according to an embodiment of the present invention;

FIG. 20 is a diagram for describing pixels included in a projection image according to an embodiment of the present invention;

FIG. 21 is a diagram for describing pixels included in a projection image according to an embodiment of the present invention;

FIG. 22 is a graph illustrating an example of the displacement amount of a DMD and a non-projection time according to an embodiment of the present invention;

FIG. 23 is a graph illustrating an example of the displacement amount of a pixel and a non-projection time according to an embodiment of the present invention;

FIG. 24 is a graph illustrating an example of the displacement amount of a pixel and a non-projection time according to an embodiment of the present invention; and

FIG. 25 is a flowchart of an example of a projection control process according to an embodiment of the present invention.

### DETAILED DESCRIPTION OF THE PREFERRED EMBODIMENTS

A problem to be solved by an embodiment of the present invention is to provide an image projection apparatus by which the resolution of projection images can be increased and images can be projected at a brightness level according to the environment.

A description will be given of embodiments with reference to the accompanying drawings.

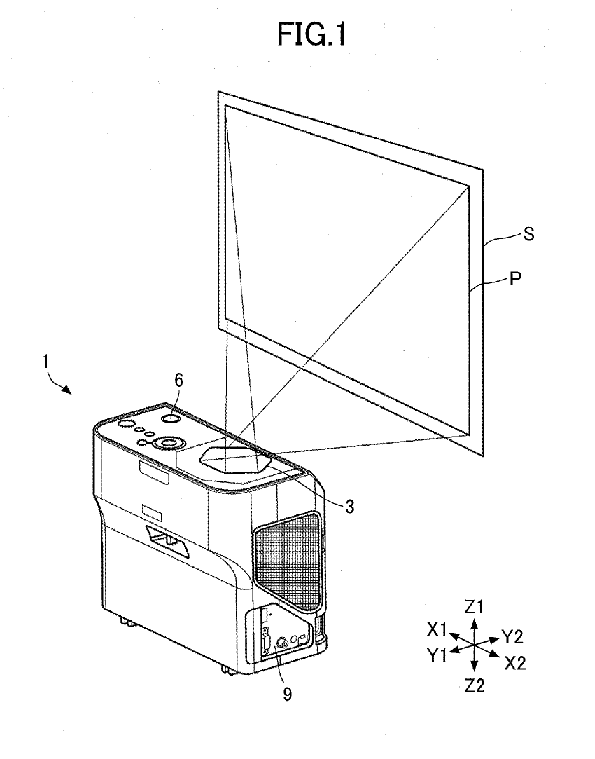

FIG. 1 is a diagram showing a projector 1 which is an image projection apparatus according to an embodiment.

As shown in FIG. 1, the projector 1 includes a radiation window 3, an illuminance meter 6, and an external interface (I/F) 9, and an optical engine which is configured to generate a projection image P is provided in the inside of the projector 1. For example, when image data is transmitted to the projector 1 from a personal computer (PC) or a digital camera connected to the external interface 9, the optical engine generates an image based on the received image data and projects the projection image P from the radiation window 3 onto a screen S as shown in FIG. 1.

Note that, in the following drawings, X1-X2 directions represent width directions of the projector 1, Y1-Y2 directions represent height directions of the projector 1, and Z1-Z2 directions represent depth directions of the projector 1. Moreover, in the following description, it is assumed that the radiation window 3 side of the projector 1 corresponds to the top of the projector 1 and the side of the projector 1 opposite to the radiation window 3 corresponds to the bottom of the projector 1.

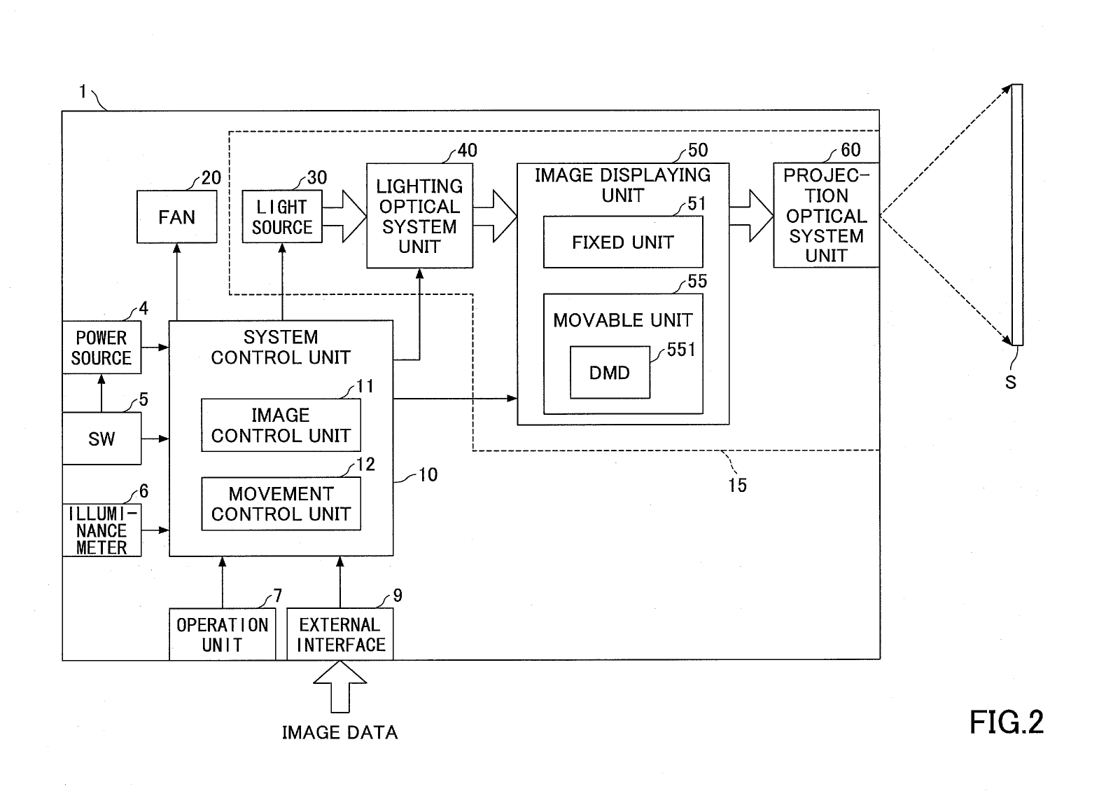

FIG. 2 is a block diagram showing a functional configuration of the projector 1.

As shown in FIG. 2, the projector 1 includes a power source 4, a main switch (SW) 5, the illuminance meter 6, an operation unit 7, an external interface (I/F) 9, a system control unit 10, a fan 20, and an optical engine 15.

The power source 4 is connected to a commercial power source, converts voltage and frequency of the commercial power for the internal circuits of the projector 1, and supplies the resulting power to each of the system control unit 10, the fan 20, and the optical engine 15.

The main switch 5 is switched ON or OFF by a user to power on or off the projector 1. While the power source 4 is connected to the commercial power source via a power cord, if the main switch 5 is switched ON, the power source 4 starts supplying power to the respective components of the projector 1, and if the main switch 5 is switched OFF, the power source 4 stops the power supply to the respective components of the projector 1.

The illuminance meter 6 is an example of an illuminance detector. The illuminance meter 6 detects the illuminance of the environment where the projector 1 is installed. Note that the illuminance meter 6 of this embodiment is provided integrally with the projector 1 and is provided for detecting the illuminance around the projector 1. However, the illuminance meter 6 may be provided as a separate body from the projector 1. When the illuminance meter 6 is provided as a separate body from the projector 1, for example, the illuminance meter 6 may be disposed near the screen S, and the illuminance meter 6 will be able to detect the illuminance around the plane of projection. The projector 1 can execute various control operations based on the illuminance detection result around the plane of projection sent from the illuminance meter 6, and optimize the projection image.

The operation unit 7 includes buttons configured to receive various input operations by a user. For example, the operation unit 7 is provided on a top surface of the projector 1. The operation unit 7 is configured to receive input operations by the user, such as selection of a size of a projection image, selection of a color tone, and adjustment of a focus. The user's input operation received by the operation unit 7 is sent to the system control unit 10.

The external interface 9 includes connection terminals connected to, for example, a personal computer (PC) or a digital camera, and is configured to supply image data, which is received from the connected apparatus, to the system control unit 10.

The system control unit 10 includes an image control unit 11 and a movement control unit 12. For example, the system control unit 10 may include a CPU (a processor), a ROM, and a RAM as hardware components thereof. The functions of the system control unit 10 may be implemented by instructions from the CPU when a program read from the ROM into the RAM is executed by the CPU.

The image control unit 11 is configured to control a digital micromirror device (DMD) 551 provided in an image displaying unit 50 of the optical engine 15 based on the image data received from the external interface 9, to generate an image to be projected on the screen S.

The movement control unit 12 is configured to move a movable unit 55 (which is provided to be movable in the image displaying unit 50) and control a position of the DMD 551 provided in the movable unit 55. The movable unit 55 is an example of a movable member.

The fan 20 is rotated under the control of the system control unit 10 to cool a light source 30 of the optical engine 15.

The optical engine 15 includes the light source 30, a lighting optical system unit 40, the image displaying unit 50, and a projection optical system unit 60. The optical engine 15 is controlled by the system control unit 10 to project an image on a screen S as shown in FIG. 1.

Examples of the light source 30 include a mercury high-pressure lamp, a xenon lamp, and a light emitting diode (LED). The light source 30 is controlled by the system control unit 10 to emit light to the lighting optical system unit 40.

The lighting optical system unit 40 includes, for example, a color wheel, a light tunnel, and relay lenses. The lighting optical system unit 40 is configured to guide the light emitted from the light source 30 to the DMD 551 provided in the image displaying unit 50.

The image displaying unit 50 includes a fixed unit 51 which is fixed and supported on the image displaying unit 50, and the movable unit 55 which is provided to be movable relative to the fixed unit 51. The fixed unit 51 is an example of a fixed member. The movable unit 55 includes the DMD 551 and a position of the movable unit 55 relative to the fixed unit 51 is controlled by the movement control unit 12 of the system control unit 10. The DMD 551 is an example of an image generator. The DMD 551 is controlled by the image control unit 11 of the system control unit 10. The DMD 551 is configured to modulate the light received from the lighting optical system unit 40 and generate a projection image based on the received light.

The projection optical system unit 60 includes, for example, a plurality of projection lenses and a mirror. The projection optical system unit 60 is configured to enlarge the image generated by the DMD 551 of the image displaying unit 50, and project the enlarged image on the screen S.

Next, a configuration of the optical engine 15 of the projector 1 is explained.

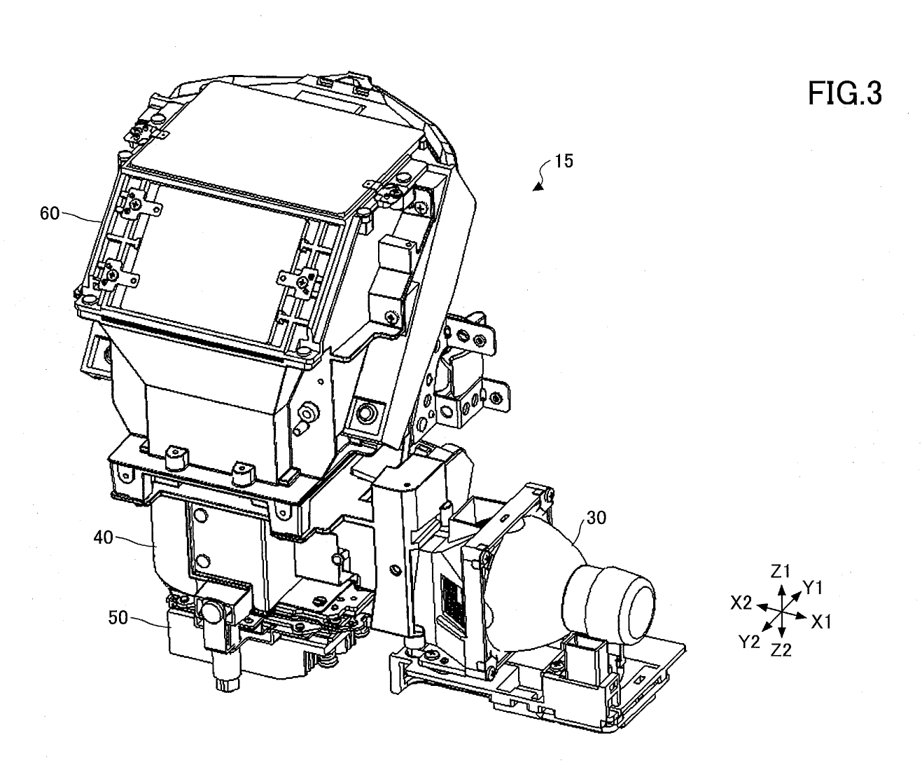

FIG. 3 is a perspective view of the optical engine 15 of the projector 1. As shown in FIG. 3, the optical engine 15 includes the light source 30, the lighting optical system unit 40, the image displaying unit 50, and the projection optical system unit 60. The optical engine 15 is provided in the inside of the projector 1.

The light source 30 is provided on a side surface of the lighting optical system unit 40. The light source 30 is configured to emit light in the X2 direction. The lighting optical system unit 40 is configured to guide the light emitted from the light source 30 to the image displaying unit 50. The image displaying unit 50 is provided beneath the lighting optical system unit 40. The image displaying unit 50 is configured to generate a projection image based on the light received from the lighting optical system unit 40. The projection optical system unit 60 is provided above the lighting optical system unit 40. The projection optical system unit 60 is configured to project the projection image generated by the image displaying unit 50 onto the screen S which is provided outside the projector 1.

The optical engine 15 of this embodiment is configured to project the image based on the light emitted from the light source 30 in an upward direction. Alternatively, the optical engine 15 may be configured to project the image in a horizontal direction.

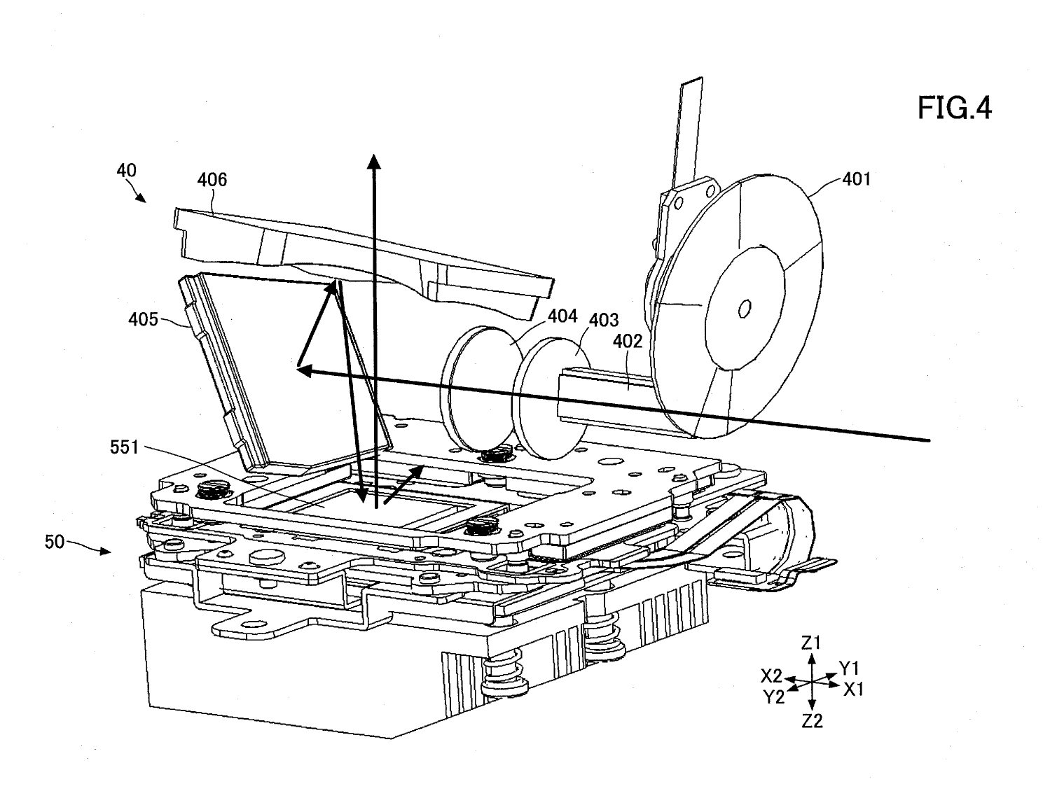

FIG. 4 is a diagram showing the lighting optical system unit 40. As shown in FIG. 4, the lighting optical system unit 40 includes a color wheel 401, a light tunnel 402, relay lenses 403 and 404, a cylinder mirror 405, and a concave mirror 406.

The color wheel 401 is, for example, a disc-like component in which color filters of R (red), G (green), and B (blue) are provided at different portions in a circumferential direction thereof. The color wheel 401 is rotated at high speed so that the light emitted from the light source 30 is divided into RGB color light beams in a time-division manner.

The light tunnel 402 is, for example, a rectangular tube-like component formed of bonded glass sheets. The light tunnel 402 functions to perform multipath reflection of the RGB color light beams passing through the color wheel 401 by the internal surfaces thereof for equalization of luminance distribution, and guides the resulting light beams to the relay lenses 403 and 404.

The relay lenses 403 and 404 function to correct the chromatic aberrations on the optical axis of the light beams emitted from the light tunnel 402 and convert the light beams into converging light beams.

The cylinder mirror 405 and the concave mirror 406 function to reflect the light emitted from the relay lens 404 to the DMD 551 provided in the image displaying unit 50. The DMD 551 is configured to modulate the light reflected from the concave mirror 406 and generate a projection image.

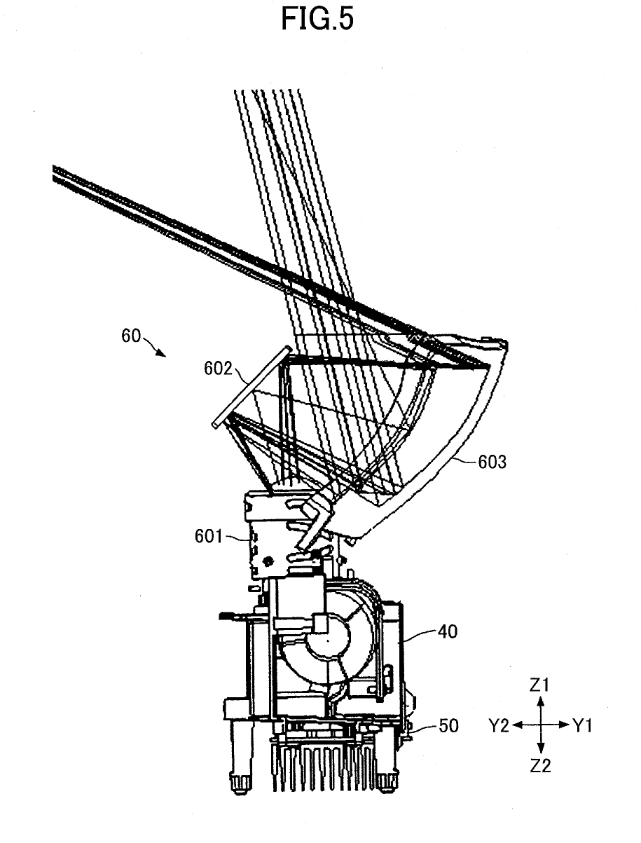

FIG. 5 is a diagram showing an internal configuration of the projection optical system unit 60. As shown in FIG. 5, the projection optical system unit 60 includes projection lenses 601, a folding mirror 602, and a curved surface mirror 603 which are provided in a housing of the projection optical system unit 60.

The projection lenses 601 include a plurality of lenses. The projection lenses 601 function to focus the projection image generated by the DMD 551 of the image displaying unit 50 onto the folding mirror 602. The folding mirror 602 and the curved surface mirror 603 function to reflect the focused projection image so as to be enlarged, and project the resulting image on the screen S which is provided outside the projector 1.

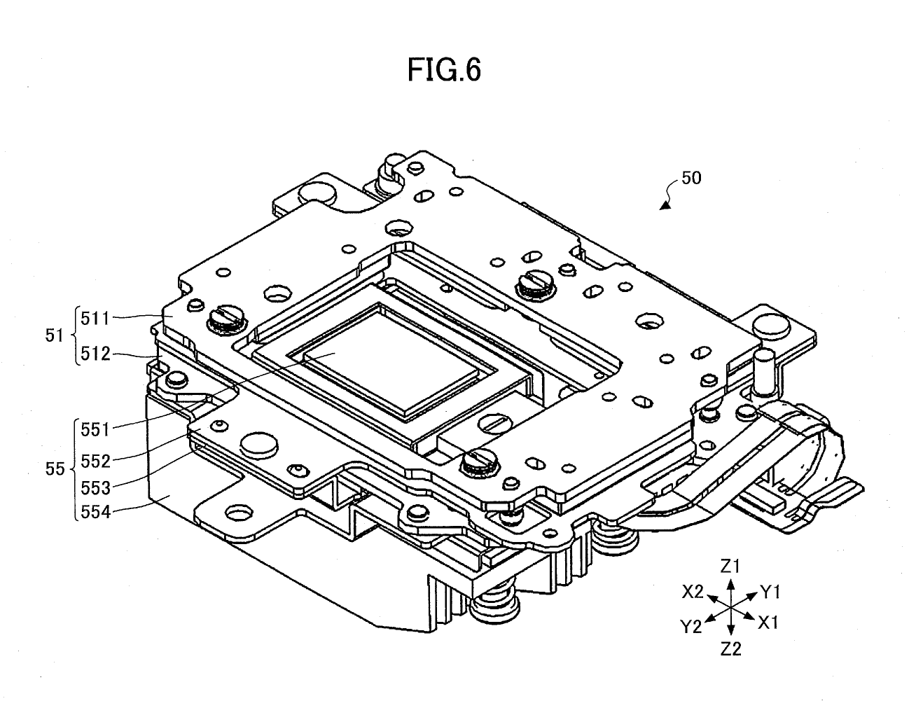

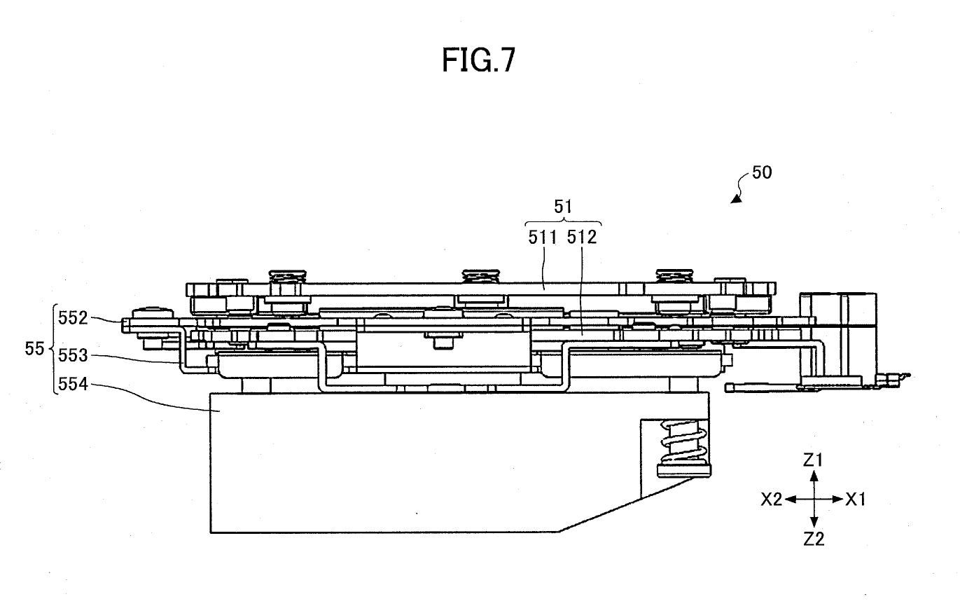

FIG. 6 is a perspective view of the image displaying unit 50. FIG. 7 is a side view of the image displaying unit 50.

As shown in FIG. 6 and FIG. 7, the image displaying unit 50 includes the fixed unit 51 which is fixed and supported, and the movable unit 55 which is provided to be movable to the fixed unit 51.

The fixed unit 51 includes a top plate 511 as a first fixed member, and a base plate 512 as a second fixed member. In the fixed unit 51, the top plate 511 and the base plate 512 are held in parallel and face each other via a predetermined gap between them. The fixed unit 51 is fixed to the bottom of the lighting optical system unit 40.

The movable unit 55 includes the DMD 551, a movable plate 552 as a first movable member, a joint plate 553 as a second movable member, and a heat sink 554. The movable unit 55 is supported to be movable relative to the fixed unit 51 by the fixed unit 51.

The movable plate 552 is provided between the top plate 511 and the base plate 512 of the fixed unit 51. The movable plate 552 is supported by the fixed unit 51 to be movable in a direction which is parallel to the top plate 511 and the base plate 512 and parallel to the surface of the movable plate 552.

The joint plate 553 is fixed to the movable plate 552 with the base plate 512 of the fixed unit 51 being inserted between the movable plate 552 and the joint plate 553. The DMD 551 is fixed to a top surface of the joint plate 553, and the heat sink 554 is fixed to a bottom surface of the joint plate 553. The joint plate 553, which is fixed to the movable plate 552, is supported by the fixed unit 51 to be movable relative to the fixed unit 51 integrally with the movable plate 552, the DMD 551, and the heat sink 554.

The DMD 551 is mounted on a surface of the joint plate 553 on the movable plate 552 side. The DMD 551 is provided to be movable integrally with the movable plate 552 and the joint plate 553. The DMD 551 includes an image generation surface on which a plurality of rotatable micromirrors are arrayed in a lattice formation. A specular surface of each of the micromirrors of the DMD 551 is provided to be slantingly rotatable around a twist shaft. The ON/OFF drive of the micromirrors of the DMD 551 is performed based on an image signal transmitted from the image control unit 11 of the system control unit 10.

For example, in an ON state, an inclination angle of a micromirror is controlled so that the micromirror reflects the light from the light source 30 to the projection optical system unit 60, and in an OFF state, the inclination angle of the micromirror is controlled so that the micromirror reflects the light from the light source 30 to an OFF light plate (which is not illustrated).

In this manner, the inclination angle of each of the micromirrors of the DMD 551 is controlled based on the image signal transmitted from the image control unit 11, and the light emitted from the light source 30 and passing through the lighting optical system unit 40 is modulated and a projection image is generated by the DMD 551.

The heat sink 554 is an example of a heat dissipation unit. The heat sink 554 is provided so that the heat sink 554 at least partially contacts the DMD 551. Integrally with the DMD 551, the heat sink 554 is mounted on the joint plate 553 which is supported to be movable, and it is possible to efficiently cool the DMD 551 by the contact of the heat sink 554 with the DMD 551. By this configuration of the heat sink 554, the projector 1 is capable of preventing the temperature of the DMD 551 from increasing and capable of reducing problems, such as malfunction and failure, due to the temperature rise of the DMD 551.

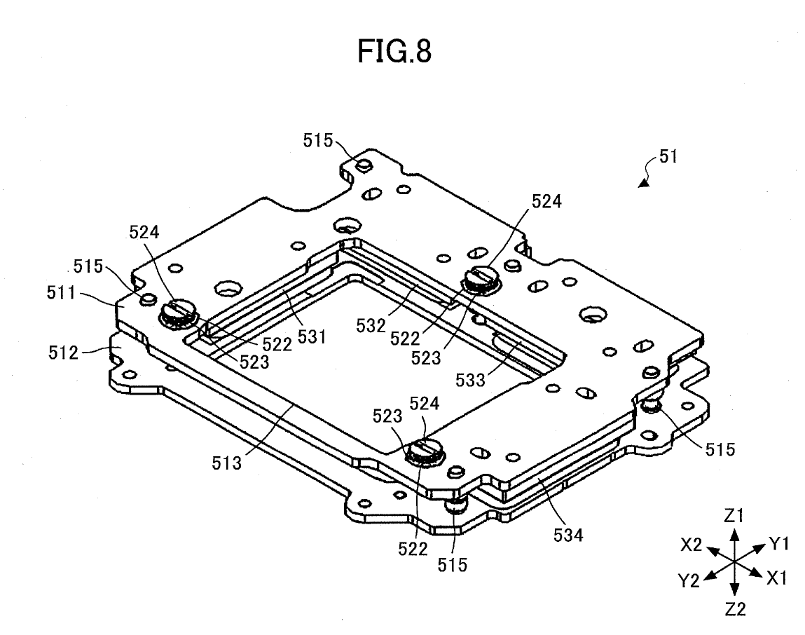

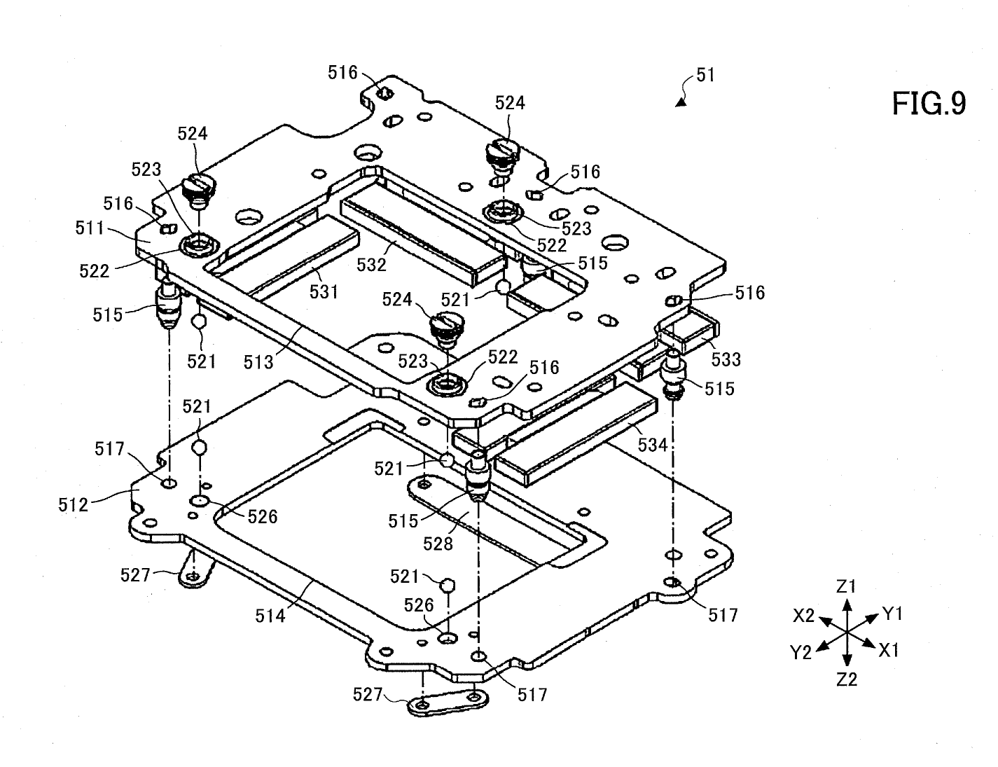

FIG. 8 is a perspective view of the fixed unit 51. FIG. 9 is an exploded perspective view of the fixed unit 51.

As shown in FIG. 8 and FIG. 9, the fixed unit 51 includes the top plate 511 and the base plate 512. The top plate 511 and the base plate 512 are made of a flat-shaped plate material. The top plate 511 has a central hole 513 formed in a position corresponding to the DMD 551 of the movable unit 55. The base plate 512 has a central hole 514 formed in a position corresponding to the DMD 551 of the movable unit 55. The top plate 511 and the base plate 512 are supported by plural supports 515 so that the top plate 511 and the base plate 512 are held in parallel and face each other via the predetermined gap between them.

As shown in FIG. 9, an upper end portion of each of the supports 515 is press fitted in a corresponding one of support holes 516 which are formed in the top plate 511, and a lower end portion of the support 515 is inserted in a corresponding one of support holes 517 which are formed in the base plate 512. The lower end portion of each of the supports 515 is formed with an external thread groove. The supports 515 support the top plate 511 and the base plate 512 so that the top plate 511 and the base plate 512 are held in parallel and face each other via the predetermined gap between them.

Moreover, support holes 522 are formed in the top plate 511 to hold support balls 521 rotatably, and support holes 526 are formed in the base plate 512 to hold support balls 521 rotatably.

Cylindrical holding members 523 each of which has an internal thread groove formed in an inner peripheral surface of the holding member 523 are inserted in the support holes 522 of the top plate 511. The holding members 523 hold the support balls 521 rotatably, respectively: Positioning screws 524 are inserted into upper end portions of the holding members 523, respectively. Lower end faces of the support holes 526 of the base plate 512 are closed by lid members 527 and 528, and the support holes 526 of the base plate 512 hold the support balls 521 rotatably.

The support balls 521 which are rotatably held by the support holes 522 and 526 of the top plate 511 and the base plate 512 are respectively in contact with the movable plate 552 provided between the top plate 511 and the base plate 512. Hence, the support balls 521 movably support the movable plate 552.

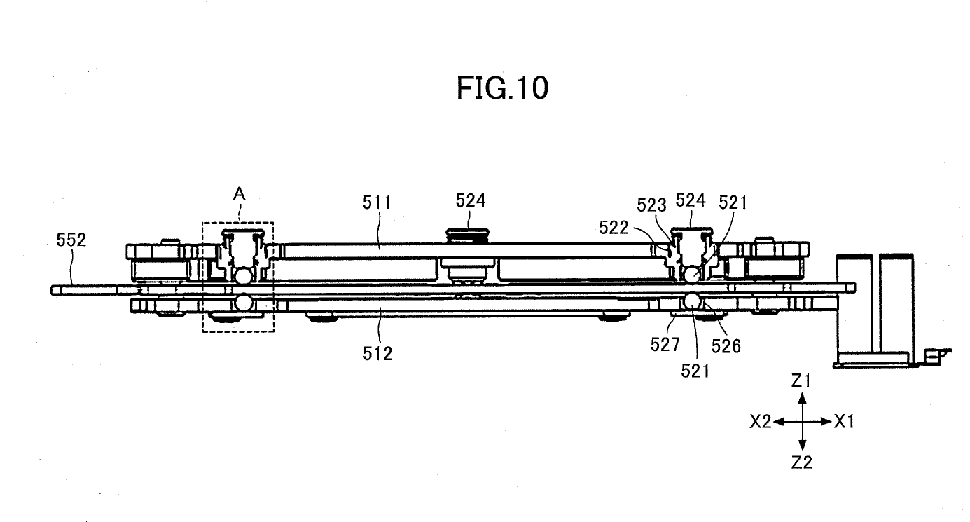

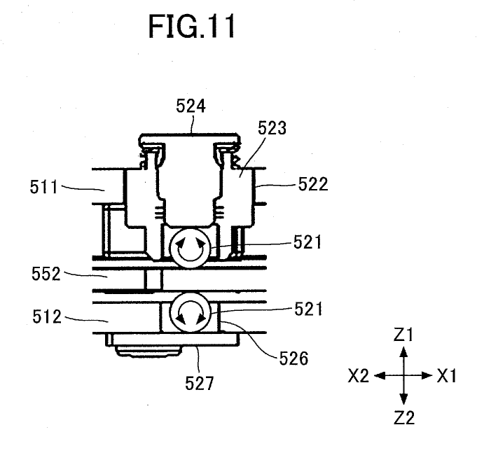

FIG. 10 is a diagram showing a support structure of the movable plate 552 by the fixed unit 51. FIG. 11 is an enlarged diagram showing a portion (indicated by the letter “A” in FIG. 10) of the support structure of the movable plate 552 by the fixed unit 51.

As shown in FIG. 10 and FIG. 11, in the top plate 511, the support balls 521 are rotatably held by the holding members 523 which are inserted in the support holes 522. In the base plate 512, the support balls 521 are rotatably held by the support holes 526 the lower end faces of which are closed by the lid members 527 and 528.

Each of the support balls 521 is held so that the support ball 521 projects at least partially from the support hole 522 or the support hole 526. Each of the support balls 521 contacts the movable plate 552 provided between the top plate 511 and the base plate 512 to support the movable plate 552. The top surface and the bottom surface of the movable plate 552 are supported by the rotatably held support balls 521 so that the movable plate 552 is movable in the direction which is parallel to the top plate 511 and the base plate 512 and parallel to the top and bottom surfaces of the movable plate 552.

Moreover, the amount of projection of the support ball 521 (provided on the top plate 511 side) from the lower end of the holding member 523 is varied depending on a position of the positioning screw 524 (which contacts the support ball 521 on the side opposite to the movable plate 552). For example, if the positioning screw 524 is displaced in the Z1 direction (upward), the amount of projection of the support ball 521 is decreased and the gap between the top plate 511 and the movable plate 552 is decreased. On the other hand, if the positioning screw 524 is displaced in the Z2 direction (downward), the amount of projection of the support ball 521 is increased and the gap between the top plate 511 and the movable plate 552 is increased.

Hence, the gap between the top plate 511 and the movable plate 552 may be appropriately adjusted by changing the amount of projection of the support ball 521 using the positioning screw 524.

Moreover, as shown in FIG. 8 and FIG. 9, magnets 531, 532, 533 and 534 are mounted on a bottom surface of the top plate 511 on the base plate 512 side.

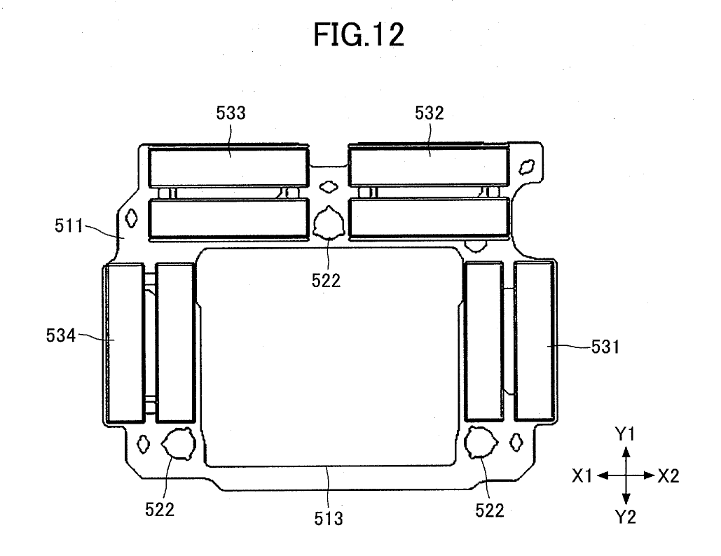

FIG. 12 is a bottom view of the top plate 511. As shown in FIG. 12, the magnets 531, 532, 533 and 534 are mounted on the bottom surface of the top plate 511 on the base plate 512 side.

The magnets 531, 532, 533 and 534 are provided at four locations which surround the central hole 513 of the top plate 511. Each of the magnets 531, 532, 533 and 534 is made of a pair of magnet pieces having a rectangular parallelepiped shape. The two magnet pieces of each pair are arranged side by side so that longitudinal directions of the two magnet pieces are parallel to each other. Each of the magnets 531, 532, 533 and 534 forms a magnetic field which functions to attract the movable plate 552.

Coils are provided on the top surface of the movable plate 552 to face the magnets 531, 532, 533 and 534, respectively. The magnets 531, 532, 533 and 534 on the top plate 511 and the corresponding coils on the movable plate 552 constitute a movement device configured to move the movable plate 552.

Note that the number and positions of the supports 515 and the support balls 521 which are provided on the fixed unit 51 are not limited to the configuration of this embodiment, and it is sufficient that the supports 515 and the support balls 521 are provided to support the movable plate 552 movably.

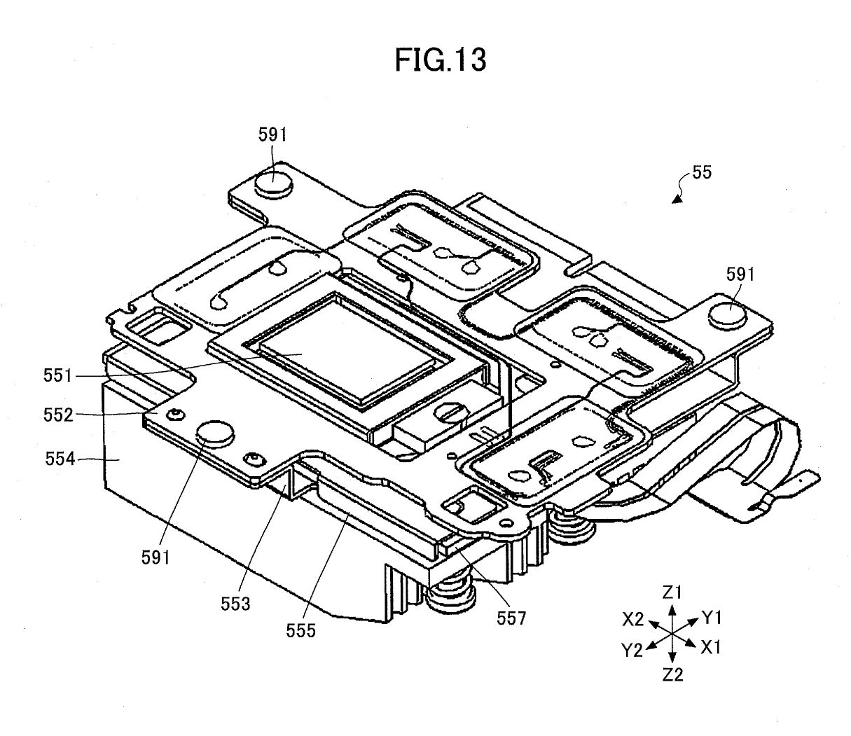

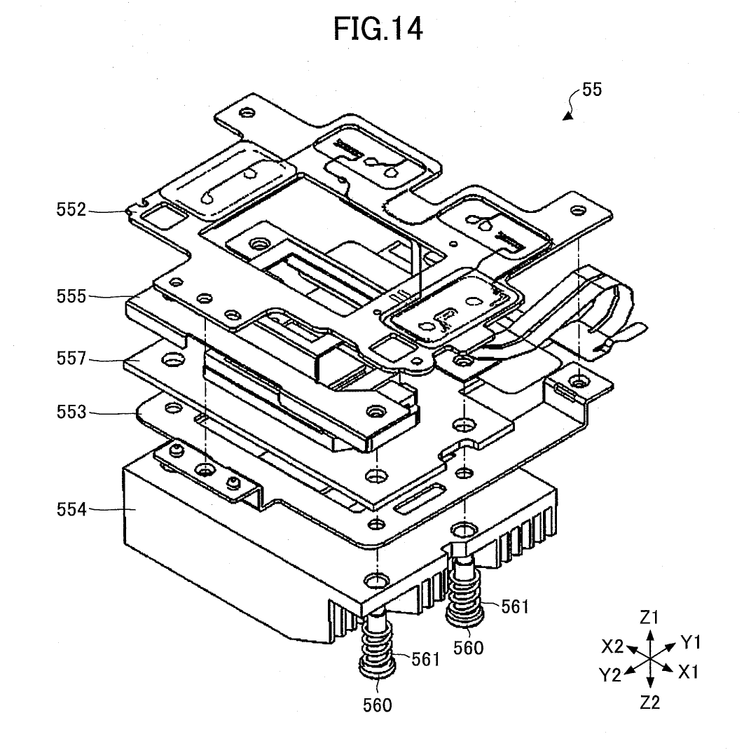

FIG. 13 is a perspective view of the movable unit 55. FIG. 14 is an exploded perspective view of the movable unit 55. As shown in FIG. 13 and FIG. 14, the movable unit 55 includes the DMD 551, the movable plate 552, the joint plate 553, the heat sink 554, a holding member 555, and a DMD base 557. The movable unit 55 is supported to be movable relative to the fixed unit 51.

As described above, the movable plate 552 is provided between the top plate 511 and the base plate 512 of the fixed unit 51 and supported by the support balls 521 to be movable in the direction parallel to the top and bottom surfaces of the movable plate 552.

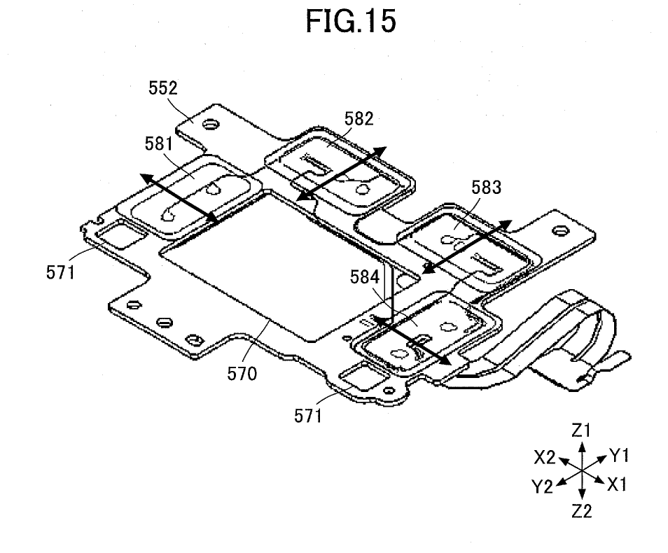

FIG. 15 is a perspective view of the movable plate 552. As shown in FIG. 15, the movable plate 552 is made of a flat-shaped plate material. The movable plate 552 has a central hole 570 in the position corresponding to the DMD 551 which is mounted on the DMD base 557, and coils 581, 582, 583 and 584 are formed on the periphery of the central hole 570.

Each of the coils 581, 582, 583 and 584 is formed of electric wires wound around a shaft parallel to the Z1-Z2 directions. The coils 581, 582, 583 and 584 are provided in recesses formed in the bottom surface of the top plate 511 on the movable plate 552 side, and the coils are enclosed with coverings. The coils 581, 582, 583 and 584 on the movable plate 552 and the magnets 531, 532, 533 and 534 on the top plate 511 constitute the movement device configured to move the movable plate 552.

In the state in which the movable unit 55 is supported by the fixed unit 51, the magnets 531, 532, 533 and 534 on the top plate 511 and the coils 581, 582, 583 and 584 on the movable plate 552 are provided to face each other, respectively. When electric current flows through the coils 581, 582, 583 and 584, Lorentz forces as driving forces to move the movable plate 552 are generated by the magnetic fields formed by the coils 581, 582, 583 and 584 and the magnets 531, 532, 533 and 534.

The movable plate 552 is linearly moved or rotated to the fixed unit 51 within an XY plane by the Lorentz forces as the driving forces which are generated by the magnets 531, 532, 533 and 534 and the coils 581, 582, 583 and 584.

The magnitude and direction of the current flowing through each of the coils 581, 582, 583 and 584 are controlled by the movement control unit 12 of the system control unit 10. The movement control unit 12 controls the direction of movement (or rotation), the amount of movement and the rotational angle of the movable plate 552 by changing the magnitude and direction of the current flowing through each of the coils 581, 582, 583 and 584.

In this embodiment, the coil 581 and the magnet 531, and the coil 584 and the magnet 534 are arranged to face each other in the X1 and X2 directions, and the coils 581 and 584 and the magnets 531 and 534 are formed as a first drive unit. If electric current flows through the coils 581 and 584, Lorentz forces in the X1 or X2 direction are generated as shown in FIG. 15. The movable plate 552 is moved in the X1 or X2 direction by the Lorentz force generated by the coil 581 and the magnet 531 and the Lorentz force generated by the coil 584 and the magnet 534.

Moreover, in this embodiment, the coil 582 and the magnet 532, and the coil 583 and the magnet 533 are arranged side by side in the X1 or X2 direction as a second drive unit, and the longitudinal direction of the magnets 532 and 533 is arranged to be perpendicular to the longitudinal direction of the magnets 531 and 534. If electric current flows through the coil 582 and the coil 583, Lorentz forces in the Y1 or Y2 direction are generated as shown in FIG. 15.

The movable plate 552 may be moved in the Y1 or Y2 direction by the Lorentz force generated by the coil 582 and the magnet 532 and the Lorentz force generated by the coil 583 and the magnet 533 with the directions of the Lorentz forces being the same. Moreover, the movable plate 552 may be rotated in the XY plane by the Lorentz force generated by the coil 582 and the magnet 532, and the Lorentz force generated by the coil 583 and the magnet 533 with the directions of the Lorentz forces being opposite to each other.

For example, if electric current is supplied so that a Lorentz force in the Y1 direction is generated by the coil 582 and the magnet 532 and a Lorentz force in the Y2 direction is generated by the coil 583 and the magnet 533, the movable plate 552 is rotated clockwise in a top view. On the other hand, if electric current is supplied so that a Lorentz force in the Y2 direction is generated by the coil 582 and the magnet 532 and a Lorentz force in the Y1 direction is generated by the coil 583 and the magnet 533, the movable plate 552 is rotated counterclockwise in a top view.

In the movable plate 552, movable range restriction holes 571 are formed at locations corresponding to the supports 515 of the fixed unit 51. The supports 515 of the fixed unit 51 are inserted in the movable range restriction holes 571. If the movable plate 552 is greatly moved due to vibration or certain malfunction, the supports 515 come in contact with the movable range restriction holes 571, and the movable range of the movable plate 552 may be restricted.

As described above, in this embodiment, the movement control unit 12 of the system control unit 10 is configured to move the movable plate 552 to an arbitrary position within the movable range by controlling the magnitude and directions of the current flowing through the coils 581, 582, 583 and 584.

Note that the number and positions of the coils 581, 582, 583 and 584 and the magnets 531, 532, 533 and 534, which constitute the movement device, are not limited to this embodiment. Another embodiment different from this embodiment may be used if the movable plate 552 can be moved to an arbitrary position. For example, the magnets in the movement device may be mounted on the top surface of the top plate 511, or mounted on any of the surfaces of the base plate 512. Alternatively, the magnets may be mounted on the movable plate 552, and the coils may be mounted on the top plate 511 or the base plate 512.

Moreover, the number, the positions, and the shape of the movable range restriction holes 571 are not limited to the configuration of this embodiment. For example, one movable range restriction hole or plural movable range restriction holes 571 may be provided. The movable range restriction holes 571 may have a rectangular or circular shape.

As shown in FIG. 13, the joint plate 553 is fixed to the bottom surface of the movable plate 552 (on the base plate 512 side), and the movable plate 552 is movably supported by the fixed unit 51. The joint plate 553 is made of a flat-shaped plate material. The joint plate 553 has a central hole in the position corresponding to the DMD 551. Folded portions provided on the periphery of the joint plate 553 are fixed to the bottom surface of the movable plate 552 by three screws 591 (see FIG. 13).

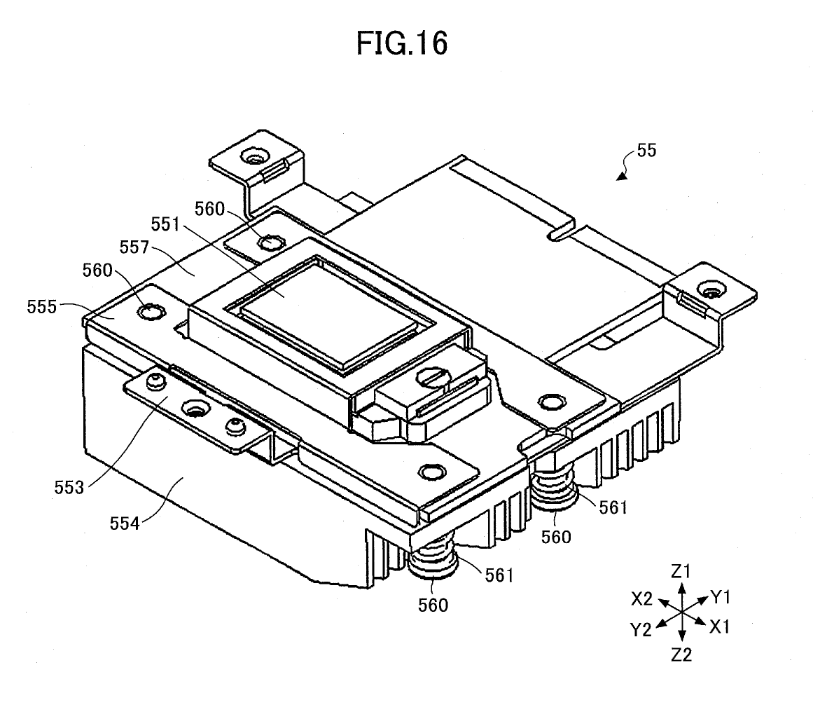

FIG. 16 is a perspective view of the movable unit 55 from which the movable plate 552 is removed. As shown in FIG. 16, the DMD 551 is mounted on the top surface of the joint plate 553 and the heat sink 554 is mounted on the bottom surface of the joint plate 553. The joint plate 553, which is fixed to the movable plate 552, is provided to be movable relative to the fixed unit 51 according to the movement of the movable plate 552 integrally with the DMD 551 and the heat sink 554.

The DMD 551 is mounted on the DMD base 557, and the DMD base 557 is interposed between the holding member 555 and the joint plate 553. Hence, the DMD 551 is fixed to the joint plate 553 via the DMD base 557. As shown in FIG. 14 and FIG. 16, the holding member 555, the DMD base 557, the joint plate 553, and the heat sink 554 are laminated and fixed by shoulder screws 560 (which are fastener members) and springs 561 (which are pressure units).

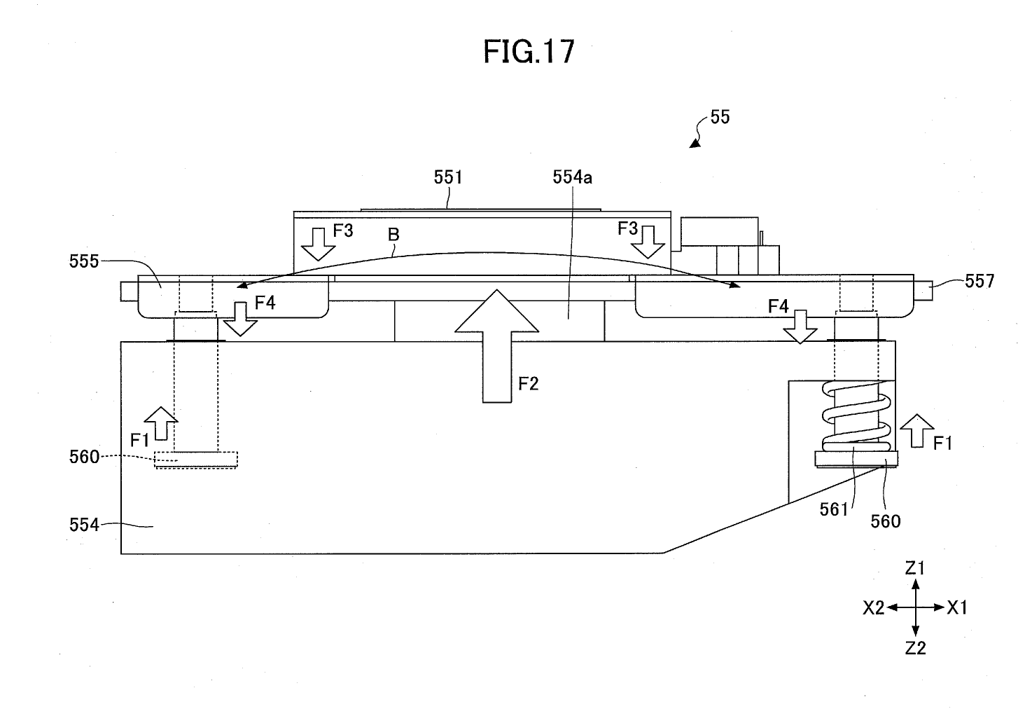

FIG. 17 is a diagram showing a DMD holding structure of the movable unit 55. FIG. 17 is a side view of the movable unit 55, and in FIG. 17, the illustration of the movable plate 552 and the joint plate 553 is omitted.

As shown in FIG. 17, the heat sink 554 includes a projection 554a which contacts the bottom surface of the DMD 551 via a through hole formed in the DMD base 557 when the heat sink 554 is fixed to the joint plate 553. Note that, alternatively, the projection 554a of the heat sink 554 may be a projection provided on the bottom surface of the DMD base 557 to contact the position of the heat sink 554 corresponding to the DMD 551.

In order to increase the effect of cooling the DMD 551 by the heat sink 554, a heat transfer sheet that is elastically deformable may be interposed between the projection 554a of the heat sink 554 and the DMD 551. In such a case, the thermal conductivity between the projection 554a of the heat sink 554 and the DMD 551 will be increased by the heat transfer sheet, and thereby the effect of cooling the DMD 551 by the heat sink 554 will be increased.

As described above, the holding member 555, the DMD base 557, and the heat sink 554 are laminated and fixed by the shoulder screws 560 and the springs 561. If the shoulder screws 560 are tightened, the springs 561 are compressed in the Z1-Z2 directions, and a force F1 in the Z1 direction (as indicated in FIG. 17) is produced by the spring 561. The heat sink 554 is pressed onto the DMD 551 by a force F2 in the Z1 direction which is the resultant of the forces F1 produced by the springs 561.

In this embodiment, the shoulder screws 560 and the springs 561 are provided at four locations, and the force F2 acting on the heat sink 554 is equal to the resultant of the forces F1 produced by the four springs 561. The force F2 from the heat sink 554 is exerted on the holding member 555 which holds the DMD base 557 on which the DMD 551 is mounted. As a result, a reaction force F3 in the Z2 direction equivalent to the force F2 from the heat sink 554 is exerted on the holding member 555, so that the DMD base 557 can be held between the holding member 555 and the joint plate 553.

A force F4 in the Z2 direction acts on the shoulder screws 560 and the springs 561 due to the force F3 acting on the holding member 555. Because the springs 561 are provided at four locations, the force F4 acting on each of the springs is equivalent to one fourth (¼) of the force F3 acting on the holding member 555, and the force F4 and the force F1 are in equilibrium.

The holding member 555 is formed like a leaf spring and made of a material which can be bent as indicated by the arrow B in FIG. 17. The holding member 555 is bent by the upward force from the projection 554a of the heat sink 554, the downward force to push back the heat sink 554 in the Z2 direction is produced by the holding member 555, and firm contact between the DMD 551 and the heat sink 554 can be maintained.

As described above, in the movable unit 55, the movable plate 552 and the joint plate 553 (on which the DMD 551 and the heat sink 554 are mounted) are movably supported by the fixed unit 51. The position of the movable unit 55 is controlled by the movement control unit 12 of the system control unit 10. Moreover, the heat sink 554 contacting the DMD 551 by pressure is mounted on the movable unit 55, and the projector 1 is capable of having reduced problems, such as malfunction and failure, due to the temperature rise of the DMD 551.

As described above, in the projector 1 of this embodiment, the DMD 551 which generates a projection image is mounted on the movable unit 55, and the position of the DMD 551 is controlled by the movement control unit 12 of the system control unit 10 together with the movable unit 55.

For example, the movement control unit 12 controls the position of the movable unit 55 by a high speed movement between positions lying apart by a distance less than the array interval of the micromirrors of the DMD 551 at a predetermined cycle corresponding to a frame rate during image projection. At this time, the image control unit 11 transmits an image signal to the DMD 551 to generate a projection image shifted according to each of the positions.

For example, the movement control unit 12 performs reciprocation movement of the DMD 551 between two positions lying apart by the distance less than the array interval of the micromirrors of the DMD 551 in the X1-X2 directions and the Y1-Y2 directions at the predetermined cycle. At this time, the image control unit 11 controls the DMD 551 to generate a projection image shifted according to each of the positions, and it is possible to make the resolution of the projection image to be twice the resolution of the DMD 551. Moreover, the resolution of the projection image can be made to be more than twice the resolution of the DMD 551 by increasing the movement range of the DMD 551.

The movement control unit 12 moves the DMD 551 and the movable unit 55 at the predetermined cycle and the image control unit 11 controls the DMD 551 to generate the projection image according to the position. Hence, it is possible to obtain the resolution of the projection image which is higher than the resolution of the DMD 551.

In the projector 1 of this embodiment, the movement control unit 12 controls the DMD 551 so that the DMD 551 is rotated integrally with the movable unit 55, and the projection image can be rotated without reducing the size of the projection image. For example, in a conventional projector in which an image generation unit, such as a DMD, is fixed, if the size of a projection image is not reduced, the projection image cannot be rotated while maintaining the aspect ratio of the projection image. In contrast, in the projector 1 of this embodiment, the DMD 551 can be rotated, and the rotation of the DMD 551 and the adjustment of the inclination can be performed without reducing the size of the projection image.

As described in the foregoing, in the projector 1 of this embodiment, the movement of the DMD 551 is possible, and it is possible to provide an increased resolution of the projection image. Moreover, the DMD 551 and the heat sink 554 to cool the DMD 551 are mounted on the movable unit 55, the heat sink 554 is brought in contact with the DMD 551, the effect of cooling the DMD 551 by the heat sink 554 is increased, and the temperature rise of the DMD 551 is prevented. Hence, the projector 1 is capable of having reduced problems, such as malfunction and failure, due to the temperature rise of the DMD 551.

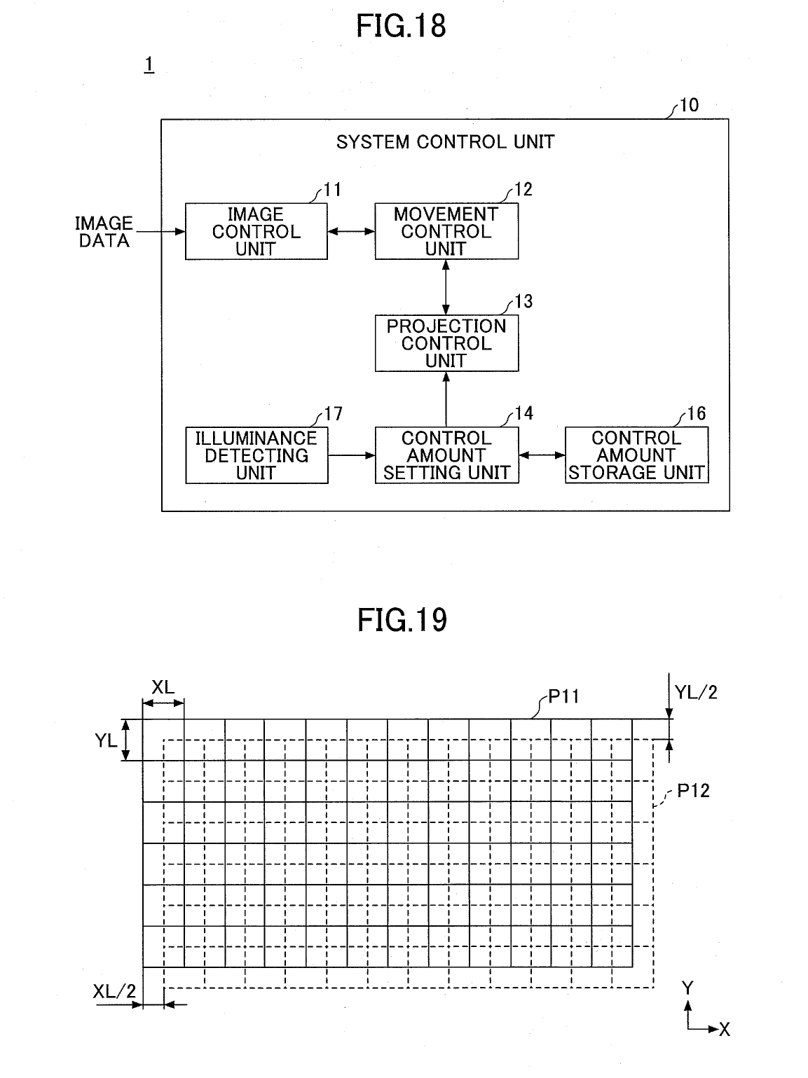

FIG. 18 is a block diagram illustrating a functional configuration of the projector 1 of this embodiment.

As illustrated in FIG. 18, the projector 1 includes the image control unit 11, the movement control unit 12, a projection control unit 13, a control amount setting unit 14, a control amount storage unit 16, and an illuminance detecting unit 17.

The image control unit 11 controls the DMD 551 based on image data that is input, to generate an image to be projected onto the screen S. The image control unit 11 controls each of the micromirrors of the DMD 551, to generate a projection image according to a position of the DMD 551 that is displaced by being controlled by the movement control unit 12.

The movement control unit 12 displaces the movable unit 55 in which the DMD 551 is included, to move the DMD 551 together with the movable unit 55. For example, as described above, the movement control unit 12 performs reciprocation movement of the DMD 551 between two positions lying apart by the distance less than the array interval of the micromirrors of the DMD 551 at the predetermined cycle. The two positions are an image generation position P1 and an image generation position P2. Note that in the following description, the image generation position P1 and the image generation position P2 may be simply referred to as a position P1 and a position P2.

FIG. 19 is a diagram illustrating an example of a projection image according to an embodiment. In FIG. 19, a projection image P11 is formed by projecting an image generated at the position P1 by the DMD 551. Furthermore, a projection image P12 indicated by dashed lines is an image formed by projecting an image generated at the position P2 by the DMD 551.

The projection image P11 and the projection image P12 are formed by a plurality of pixels in a square shape including one side having a length XL in the X direction and another side having a length YL in the Y direction in FIG. 19. The pixels in the projection image P11 and the projection image P12 are formed to correspond to the plurality of micromirrors disposed in the DMD 551.

As illustrated in FIG. 19, for example, the movement control unit 12 performs a reciprocation movement of the DMD 551 between the position P1 and the position P2, to displace the pixels in a projection image P by half a pixel in the X direction and the Y direction (XL/2 in the X direction and YL/2 in the Y direction).

The projection control unit 13 controls the optical engine 15 that is a projector, such that an image is not projected during a non-projection time set by the control amount setting unit 14, while the DMD 551 moves between the position P1 and the position P2.

The projection control unit 13 controls the optical engine 15, for example, such that the light source 30 is turned off during the non-projection time. When the light source 30 is turned off, a projection image is not generated at the DMD 551, and an image is not projected to the screen from the projector 1. Furthermore, the projection control unit 13 may control the micromirrors of the DMD 551 such that the DMD 551 reflects the light from the light source 30 toward the OFF light plate during the non-projection time. In this case, light is not guided from the DMD 551 to the projection optical system unit 60 and an image is not projected from the projector 1 to the screen.

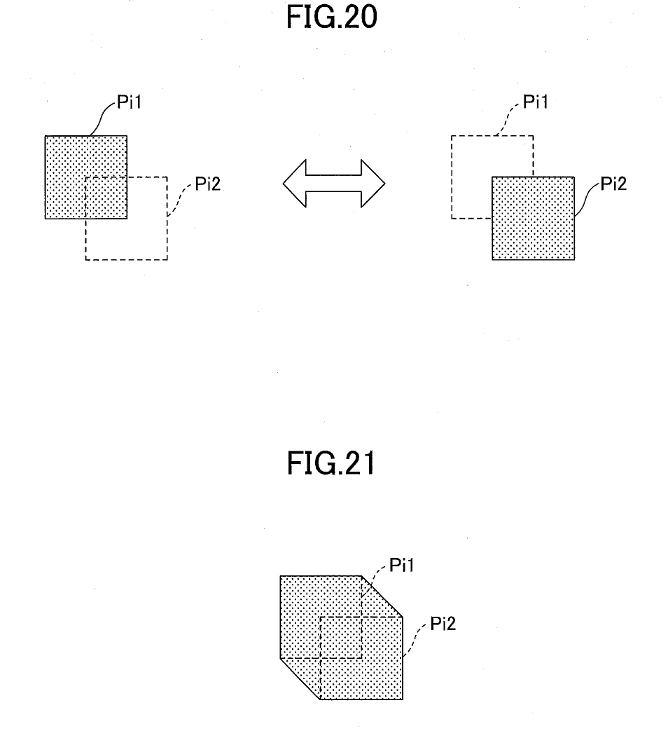

Here, FIGS. 20 and 21 are diagrams illustrating examples of pixels forming the projection images. In FIGS. 20 and 21, a pixel Pi1 is a pixel included in the projection image P11 generated at the position P1 by the DMD 551. A pixel Pi2 is a pixel included in the projection image P12 generated at the position P2 by the DMD 551. Furthermore, the pixel Pi1 and the pixel Pi2 are pixels generated by the same micromirror in the DMD 551 that performs a reciprocation movement between the position P1 and the position P2, and the state of the pixel illustrated by hatching expresses a state where an image is projected.

FIG. 20 is a diagram of an example where control is implemented such that an image is projected only while the DMD 551 is at the position P1 or the position P2, and an image is not projected while the DMD 551 is moving between the position P1 and the position P2. As described above, by implementing control such that an image is not projected while the DMD 551 is moving, it is possible to form the projection image P11 and the projection image P12 according to the position P1 and the position P2, and increase the resolution of the projection image P. However, an image is not projected while the DMD 551 is moving between the position P1 and the position P2, and therefore, for example, when the environment where the projector 1 is installed is bright, the projection image P may be dark and difficult to view.

On the other hand, FIG. 21 is a diagram illustrating an example where control is implemented such that an image is constantly projected even while the DMD 551 is moving between the position P1 and the position P2. In this way, by projecting an image even while the DMD 551 is moving, the brightness level of the projection image P can be maintained. However, in this case, the pixel Pi1 and the pixel Pi2 are coupled in the projection image P, and therefore the effect of increasing the resolution by shifting the projection image P may decrease and the image quality may decrease.

Therefore, in this embodiment, the control amount setting unit 14 sets a non-projection time in which images are not projected while the DMD 551 is moving, such that the resolution of the projection image P can be increased and the brightness level of the projection image P can be maintained.

The control amount setting unit 14 acquires the illuminance measured by the illuminance meter 6 from the illuminance detecting unit 17, and acquires the non-projection time and the light quantity of the light source 30 corresponding to the illuminance as control amounts, from the control amount storage unit 16 storing a control table in which non-projection times are stored in association with the illuminance.

The control amount storage unit 16 stores a control table including the non-projection time and the light quantity of the light source 30, by which the resolution of the projection image P can be increased and the projection image P can be maintained at a brightness level that is easy to view, according to the illuminance measured by the illuminance meter 6. The control amount setting unit 14 acquires the non-projection time and the light quantity of the light source 30 corresponding to the illuminance from the control table stored in the control amount storage unit 16. The control amount setting unit 14 sets the acquired control amounts in the projection control unit 13.

The projection control unit 13 implements controls such that the optical engine 15 does not project images while the DMD 551 is moving between the position P1 and the position P2, for example, by turning off the light source 30 during the non-projection time set by the control amount setting unit 14.

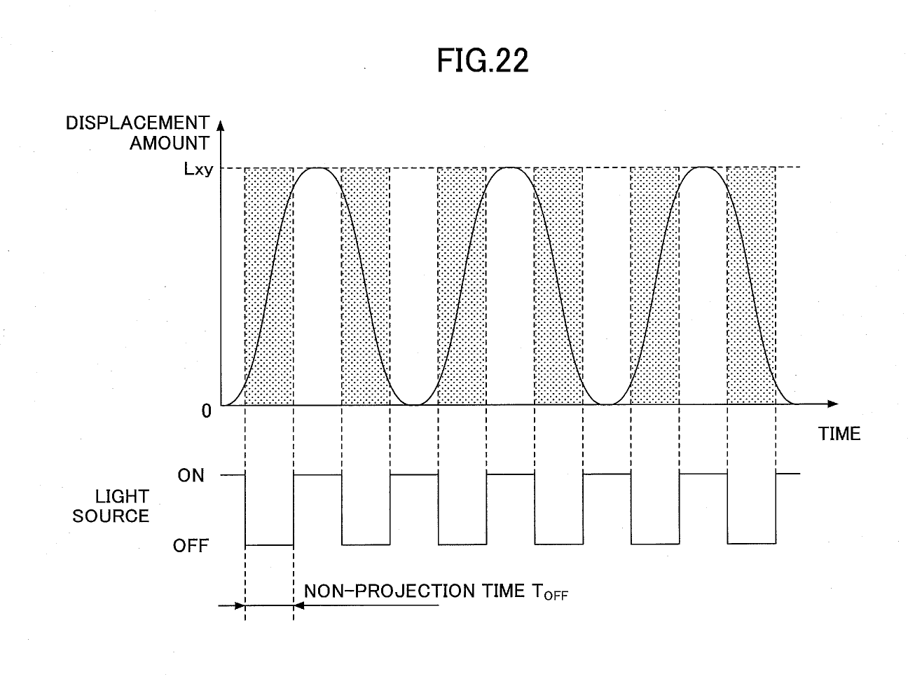

FIG. 22 is a graph illustrating an example of the displacement amount of the DMD 551 and the non-projection time. In the graph in the top stage of FIG. 22, the horizontal axis indicates the time and the vertical axis indicates the displacement amount of the DMD 551 from the position P1. Furthermore, the bottom stage in FIG. 22 illustrates a timing chart of turning on or off the light source 30.

As illustrated in the graph in the top stage of FIG. 22, the DMD 551 is controlled by the movement control unit 12 to perform a reciprocation movement between the position P1 (displacement amount is zero) and the position P2 (displacement amount is Lxy). Furthermore, while the DMD 551 is moving between the position P1 and the position P2, the projection control unit 13 implements control such that the light source 30 is turned off during a non-projection time T_{OFF} set by the control amount setting unit 14. As the light source 30 is turned off while the DMD 551 is moving, the resolution of the projection image P can be increased.

Here, the control table stored in the control amount storage unit 16 is set such that the non-projection time T_{OFF} decreases as the illuminance detected by the illuminance meter 6 increases, and the non-projection time T_{OFF} increases as the illuminance decreases.

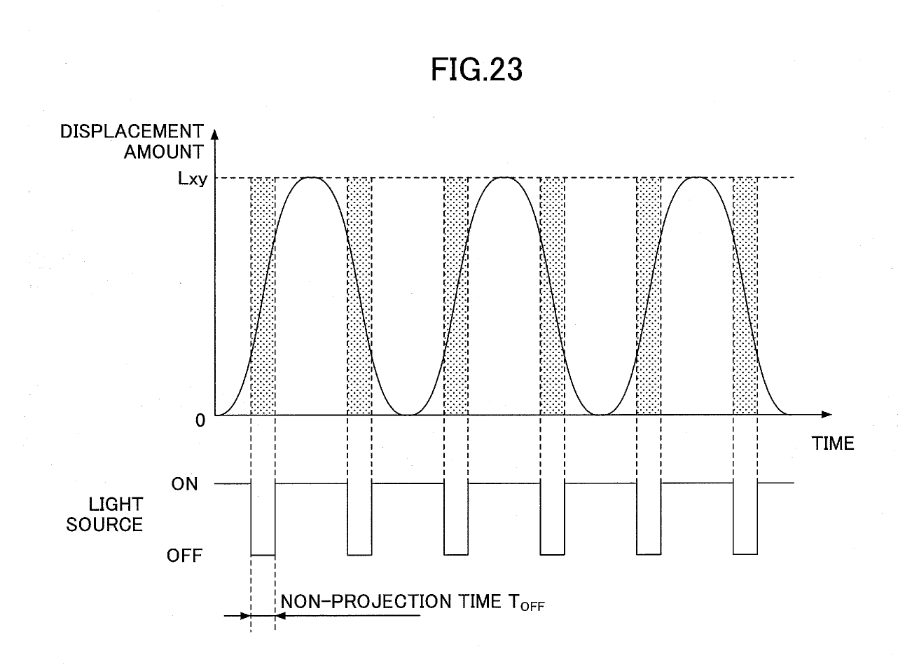

As illustrated in FIG. 23, when the illuminance measured by the illuminance meter 6 is high, control is implemented to decrease the non-projection time T_{OFF} and increase the time of projecting images, such that the brightness level of the projection image P is increased. As the brightness level of the projection image P increases, even when the lighting, etc., in a room where the projector 1 is installed is bright, the projection image P projected by the projector 1 can be easily viewed.

However, if the non-projection time T_{OFF} is excessively decreased, the images will be projected in a state where the pixels are nearly coupled as illustrated in FIG. 21. Consequently, the effect of increasing the resolution of the projection image P may be decreased. Therefore, the non-projection time T_{OFF} is required to be set within a range where the effect of increasing the resolution of the projection image P can be obtained. Furthermore, when the non-projection time T_{OFF} is set to be as short as possible, and the brightness level of the projection image P is to be further increased, the projection control unit 13 controls the light source 30 to emit light by the light quantity set in the control amount setting unit 14.

As described above, when the environment where the projector 1 is installed is bright, the non-projection time T_{OFF} is decreased and the projection time is increased within a range where the resolution of the projection image P can be increased. Accordingly, it is possible to increase the resolution of the projection image P and also increase the brightness level of the projection image P such the image can be easily viewed.

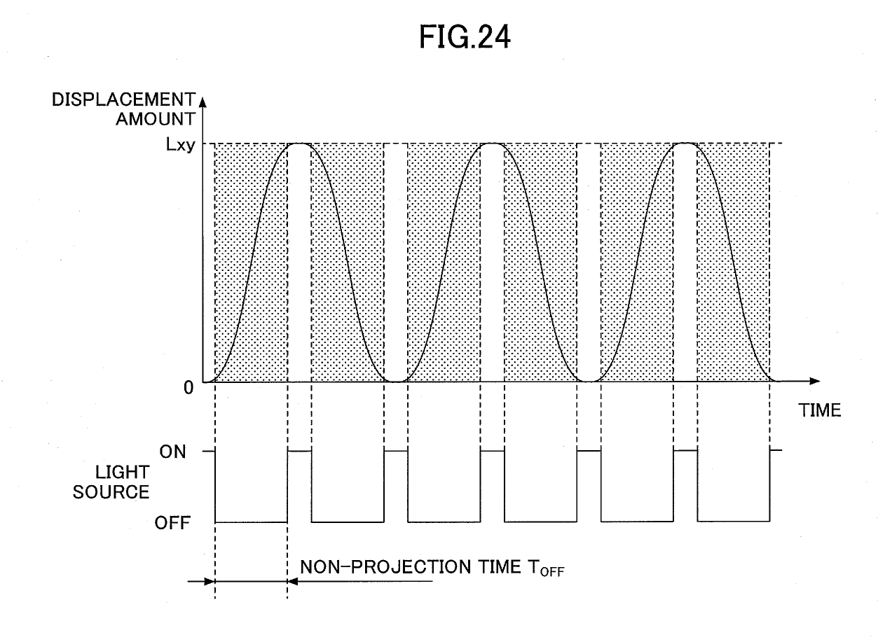

Furthermore, as illustrated in FIG. 24, when the illuminance measured by the illuminance meter 6 is low, the non-projection time T_{OFF} is increased within a range where the projection image does not become too dark and difficult to view. By increasing the non-projection time T_{OFF} and decreasing the time of projecting images, and generating images at the DMD 551 only while the DMD 551 is near the position P1 and the position P2, the effect of increasing the resolution of the projection image P can be maximized and the image quality of the projection image P can be further improved. Furthermore, when the environment where the projector 1 is installed is dark, even when the non-projection time T_{OFF} is increased and the brightness level of the projection image P is decreased, the ease of viewing the projection image P can be maintained.

As described above, when the environment where the projector 1 is installed is dark, by increasing the non-projection time T_{OFF} and decreasing the projection time of images, the brightness level of the projection image P can be decreased within a range where the projection image P does not become difficult to view, the resolution of the projection image P can be increased, and the image quality can be improved.

Note that as the light source 30, for example, an LED is preferably used because the light quantity can be adjusted and the light can be turned on and off at high speed. However, as long as the light quantity can be adjusted and the light can be turned on and off at high speed, the light source 30 is not limited to an LED.

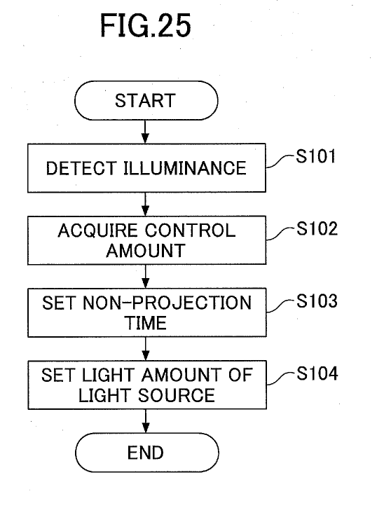

FIG. 25 is a flowchart of an example of a projection control process according to an embodiment. The projection control process illustrated in FIG. 25 is executed at a predetermined cycle while the projector 1 is projecting images. Furthermore, the projection control process may be executed at any timing according to an operation by the user.

In the projection control process according to this embodiment, first, in step S101, the illuminance meter 6 detects the illuminance in the environment where the projector 1 is installed, and the illuminance detecting unit 17 acquires the illuminance detection result from the illuminance meter 6.

Next, in step S102, the control amount setting unit 14 acquires, from the control amount storage unit 16, the control amount corresponding to the illuminance acquired by the illuminance detecting unit 17. The control amount setting unit 14 acquires the non-projection time T_{OFF} and the light quantity of the light source 30 corresponding to the illuminance, from a control table stored in the control amount storage unit 16.

As described above, the control amount storage unit 16 stores a control table in which the illuminance and the non-projection time T_{OFF} are associated with each other, such that the non-projection time T_{OFF} decreases as the illuminance increases and the non-projection time T_{OFF} increases as the illuminance decreases. Note that the control amount setting unit 14 may obtain the non-projection time T_{OFF} corresponding to the illuminance, for example, based on a calculating formula set in advance.

In step S103, the control amount setting unit 14 sets the non-projection time T_{OFF} acquired from the control amount storage unit 16, in the projection control unit 13. The projection control unit 13 controls the optical engine 15 not to project images during the set non-projection time T_{OFF}. For example, the projection control unit 13 turns off the light source 30 or controls the micromirrors such that the DMD 551 reflects the light from the light source 30 toward the OFF light plate.

In step S104, the control amount setting unit 14 sets the light quantity of the light source 30 acquired from the control amount storage unit 16, in the projection control unit 13. The projection control unit 13 controls the light source 30 to emit light by the set light quantity.

By repeatedly executing the above projection control process while the projector 1 is projecting images, the resolution of the projected images is increased and the images can be projected at a brightness level according to the environment where the projector 1 is installed.

As described above, the projector 1 according to this embodiment implements control such that images are not projected during the set non-projection time T_{OFF} while the DMD 551 is moving between the position P1 and the position P2. Accordingly, the resolution of the projection image P can be increased and the image quality can be improved. Furthermore, the non-projection time T_{OFF} is set according to the illuminance of the environment where the projector 1 is installed, and therefore images can be projected at a brightness level according to the environment.

Note that in the above embodiment, a description is given of a case where the DMD 551 performs a reciprocation movement between the position P1 and the position P2. However, the DMD 551 may be controlled to move among three or more positions. In this case also, as described in the above embodiment, by implementing control such that images are not projected during the non-projection time, which is set according to the illuminance of the environment where the projector is installed, while the DMD 551 is moving among the image generation positions, the resolution of the projection image P can be increased and images can be projected at a brightness level according to the environment in which the projector is installed.

According to one embodiment of the present invention, an image projection apparatus, by which the resolution of a projection image is increased and an image can be projected at a brightness level according to the environment, is provided.

The image projection apparatus and the image projection method are not limited to the specific embodiments described in the detailed description, and variations and modifications may be made without departing from the spirit and scope of the present invention.

What is claimed is:

1. An image projection apparatus comprising:
a projector including:
a light source; and
an image generator configured to use light emitted from the light source to generate a projection image while moving between a plurality of image generation positions;
an illuminance detector configured to detect illuminance in an environment in which the image projection apparatus is disposed;
a control amount setter configured to set a non-projection time based on the illuminance detected by the illuminance detector; and
a projection controller configured to control the projector so as not to generate the projection image during the non-projection time, while the image generator is moving between the plurality of image generation positions.

2. The image projection apparatus according to claim 1, wherein the control amount setter decreases the non-projection time as the illuminance detected by the illuminance detector increases, and increases the non-projection time as the illuminance detected by the illuminance detector decreases.

3. The image projection apparatus according to claim 1, wherein the control amount setter controls a light quantity of the light source during a projection time in which the projection image is generated, based on the illuminance detected by the illuminance detector.

4. The image projection apparatus according to claim 1, wherein the projection controller controls the light source to be turned off during the non-projection time.

5. The image projection apparatus according to claim 1, wherein the projection controller controls the image generator so as not to generate the projection image during the non-projection time.

6. The image projection apparatus according to claim 1, wherein
the image generator includes a digital micromirror device in which a plurality of micromirrors, which are configured to modulate the light emitted from the light source, are arrayed, and
an interval between the plurality of image generation positions is less than an array interval between the plurality of micromirrors.

7. A method for projecting an image performed by an image projection apparatus including a projector including a light source and an image generator configured to use light emitted from the light source to generate a projection image while moving between a plurality of image generation positions, the method comprising:
detecting illuminance in an environment in which the image projection apparatus is disposed;
setting a non-projection time based on the detected illuminance; and
controlling the projector so as not to generate the projection image during the non-projection time, while the image generator is moving between the plurality of image generation positions.
